(19) United States
(12) Patent Application Publication
(10) Pub. No.: US 2025/0286328 A1
(43) Pub. Date: Sep. 11, 2025

(54) CABLE CONNECTOR ASSEMBLY HAVING CONNECTOR IDENTIFICATION MODULE

(71) Applicant: TE Connectivity Solutions GmbH, Schaffhausen (CH)

(72) Inventors: David Allison Trout, Middletown, PA (US); Albert Tsang, Middletown, PA (US); Linda Ellen Shields, Middletown, PA (US); Julia Anne Lachman, Middletown, PA (US)

(21) Appl. No.: 19/051,303

(22) Filed: Feb. 12, 2025

Related U.S. Application Data
(60) Provisional application No. 63/563,838, filed on Mar. 11, 2024.

(51) Int. Cl. H01R 13/66; H01R 12/62; H01R 13/6592

(52) U.S. Cl. CPC H01R 13/6691; H01R 12/62; H01R 13/6592

(57) ABSTRACT

A cable connector assembly includes a cable connector that includes a connector housing extending between a mating end and a cable end. The cable connector includes cable modules received in a cavity in a module stack. Each cable module includes a module housing holding signal contacts and cables terminated to the signal contacts. The cable connector includes a connector identification module received in the cavity configured to be mated with the mating connector assembly with the cable modules. The connector identification module includes an identification device held by an identification module housing. The identification device has unique identification data stored on the identification device. The identification device is operably coupled to the identification contact to transmit the unique identification data to the mating connector assembly.

### CROSS REFERENCE TO RELATED APPLICATIONS

This application claims benefit to U.S. Provisional Application No. 63/563,838, filed 11 Mar. 2024, titled “CABLE CONNECTOR ASSEMBLY HAVING CONNECTOR IDENTIFICATION MODULE”, the subject matter of which is herein incorporated by reference in its entirety.

### BACKGROUND OF THE INVENTION

The subject matter herein relates generally to communication systems.

Cable assemblies are used to electrically connect various components within a system, such as a server or network system. The cable assemblies extend between the components, such as network, compute, storage, memory, or other components. The components may be arranged in shelves or trays of a network rack. Some systems may include components such as cards, such as line cards, daughter cards, mother boards, and the like. Each cable assembly includes multiple cables arranged in a bundle or array. Each cable forms a data channel. As the density of cable assemblies in the network system increase, it is desirable to know the locations of the components within the system, such as for service, repair or replacement.

A need remains for a method and device for identifying components and locations of components within a network system.

### BRIEF DESCRIPTION OF THE INVENTION

In one embodiment, a cable connector assembly is provided and includes a cable connector that includes a connector housing extending between a mating end and a cable end. The connector housing has walls to define a cavity. The cable connector includes cable modules received in the cavity. Each cable module includes a module housing, signal contacts held by the module housing, and cables held by the module housing. The signal contacts are arranged at the mating end and are configured to be mated with a mating connector assembly. The cables are terminated to the signal contacts and extend from the cable end of the cable connector. The cables define data channels. The cable connector includes a connector identification module received in the cavity and is configured to be mated with the mating connector assembly. The connector identification module includes an identification module housing, identification contacts held by the identification module housing, and an identification device held by the identification module housing. The identification contacts are arranged at the mating end and are configured to be mated with the mating connector assembly. The identification device has unique identification data stored on the identification device. The identification device is operably coupled to the identification contact to transmit the unique identification data to the mating connector assembly.

In another embodiment, a connector identification module is provided and includes an identification module housing that includes a housing body extending between a front and a rear. The housing body includes a first side and a second side. The housing body includes a top and a bottom. The identification module housing includes an inner cavity at least partially surrounded by the housing body. The connector identification module includes an identification contact assembly received in the inner cavity and held by the housing body. The identification contact assembly includes a contact holder holding identification contacts. The identification contacts include mating ends that extend forward of the front of the housing body for mating with a mating connector assembly. The connector identification module includes an identification device received in the inner cavity and held by the housing body. The identification device has unique identification data stored on the identification device. The identification device is operably coupled to the identification contacts to transmit the unique identification data to the mating connector assembly.

In a further embodiment, a communication system is provided and includes a cartridge that has panels forming a chamber. The cartridge includes ports at a front of the cartridge. The communication system includes cable connector assemblies received in the ports for mating with mating connector assemblies. Each cable connector assembly includes a cable connector and a connector identification module. The cable connector includes a connector housing extending between a mating end and a cable end. The connector housing has walls that define a cavity. The cable connector includes cable modules received in the cavity. Each cable module includes a module housing, signal contacts held by the module housing, and cables held by the module housing. The signal contacts are arranged at the mating end and configured to be mated with the corresponding mating connector assembly. The cables are electrically connected to the signal contacts and extend from the cable end of the cable connector. The cables define data channels. The connector identification module is received in the cavity and configured to be mated with the mating connector assembly. The connector identification module includes an identification module housing, identification contacts held by the identification module housing, and an identification device held by the identification module housing. The identification contacts are arranged at the mating end and configured to be mated with the mating connector assembly. The identification device has unique identification data stored on the identification device. The identification device is operably coupled to the identification contact to transmit the unique identification data to the mating connector assembly.

### BRIEF DESCRIPTION OF THE DRAWINGS

FIG. 1 is a front view of a communication system in accordance with an exemplary embodiment.

FIG. 2 is a front view of a portion of the communication system in accordance with an exemplary embodiment.

FIG. 3 illustrates a portion of the communication system showing two of the cartridges in accordance with an exemplary embodiment.

FIG. 4 is a perspective view of a portion of the communication system showing one of the mating connector assemblies poised for coupling to the corresponding connector assembly in accordance with an exemplary embodiment.

FIG. 5 is a front perspective view of one of the connector assemblies in accordance with an exemplary embodiment.

FIG. 6 is a front perspective view of one of the contact modules in accordance with an exemplary embodiment.

FIG. 7 is an enlarged view of the mating end of the contact module in accordance with an exemplary embodiment.

FIG. 8 is a perspective view of the identification contact module in accordance with an exemplary embodiment.

FIG. 9 is a perspective view of a portion of the identification contact module in accordance with an exemplary embodiment with a device shell of the identification contact module removed to illustrate internal components of the identification contact module.

FIG. 10 is a perspective view of a portion of the identification contact module in accordance with an exemplary embodiment with a housing of the identification contact module removed to illustrate internal components of the identification contact module.

FIG. 11 is a perspective view of a portion of the identification contact module in accordance with an exemplary embodiment showing the identification device.

FIG. 12 is a front perspective view of the cable connector showing the identification contact module poised for loading into the cable connector in accordance with an exemplary embodiment.

FIG. 13 is a rear perspective view of the cable connector showing the identification contact module loaded into the cable connector.

FIG. 14 is a perspective view of the identification contact module showing an electronic device of the identification device in accordance with an exemplary embodiment.

FIG. 15 is a rear perspective view of the cable connector showing the identification contact module shown in FIG. 14 loaded into the cable connector.

### DETAILED DESCRIPTION OF THE INVENTION

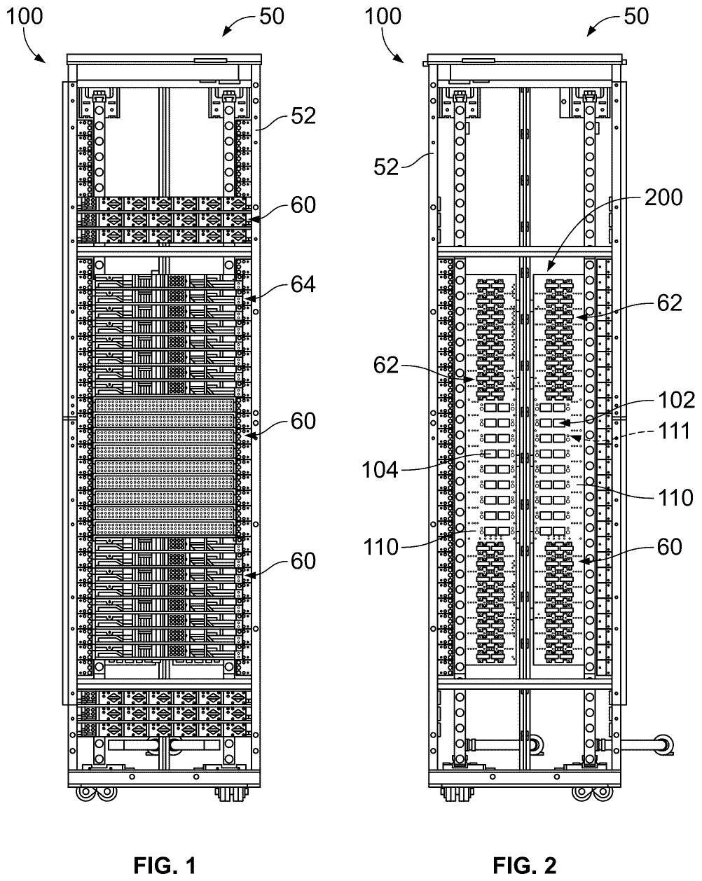

FIG. 1 is a front view of a communication system 100 in accordance with an exemplary embodiment. FIG. 2 is a front view of a portion of the communication system 100 in accordance with an exemplary embodiment. In an exemplary embodiment, the communication system 100 includes a chassis or rack 50 having a rack frame 52 holding electrical components 60. The rack 50 may be a server rack. The electrical components 60 may include fixed modules 62 (FIG. 2) and/or removable modules 64 (FIG. 1). The removable modules 64 may be mated to the fixed modules 62. For example, the removable modules 64 may be plugged into the rack frame 52 and removable from the rack frame 52. In various embodiments, the electrical components 60 may include one or more patch panels, switches, servers, routers, firewalls, and the like. The rack frame 52 may hold a power supply, cooling components, and the like.

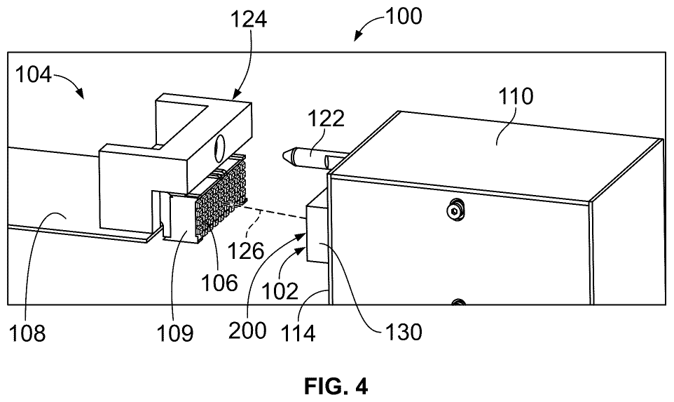

In an exemplary embodiment, the communication system 100 includes at least one connector assembly 102 (FIG. 2) and at least one mating connector assembly 104 (FIG. 4) configured to be mated with the corresponding at least one connector assembly 102. The connector assembly 102 may be part of one of the electrical components 60, such as one of the fixed modules 62. The mating connector assembly 104 may be part of one of the electrical components 60, such as one of the removable modules 64. In various embodiments, each mating connector assembly 104 may include one or more mating electrical connectors mounted to a circuit board, such as a backplane, a daughter card, a network switch, and the like.

In an exemplary embodiment, the communication system 100 includes a connector identification system 200 to identify the various connector assemblies 102 and/or mating connector assemblies 104. The connector identification system 200 may be used to identify physical locations of the connector assemblies 102 within the communication system 100, such as to identify which connector in a cable harness is electrically connected to which electrical component 60 for system management. In an exemplary embodiment, the connector identification system 200 may use identification devices, such as EEPROMs (Electrically Erasable and Programmable Read Only Memory), to hold information that allows identification of the various connector assemblies 102. The identification devices may be incorporated with each of the connector assemblies 102. For example, the identification devices may be incorporated into the connector assembly 102, such as housed within the connector assembly and having a mating interface configured to mate with the mating connector assembly 104. The identification devices may have unique identification information programmed into the identification devices, such as a part number, a program name, a slot ID number, data about the associated connector assembly 102, and the like. In an exemplary embodiment, the identification devices are modular and may be incorporated into different types of connector assemblies 102.

In an exemplary embodiment, the communication system 100 includes a cabinet or cartridge 110 that holds the connector assemblies 102. The connector assemblies 102 may be cable connector assemblies having cables extending from corresponding cable connectors. The cartridge 110 may form part of the fixed modules 62. Optionally, multiple cartridges 110 may be provided (for example, left side and right side). The cartridge 110 may be coupled to the rack frame 52, such as at the rear of the rack frame 52. The cartridge 110 forms an enclosed space or chamber 111 for the connector assemblies 102 and the cables of the connector assemblies 102. The cartridge 110 is used for cable management. For example, the cables may be part of cable harnesses routed within the enclosed chamber 111 formed by the cartridge 110 electrically connecting the various connector assemblies 102. The cartridge 110 is used to support or position the connector assemblies 102 for mating with the mating connector assemblies 104.

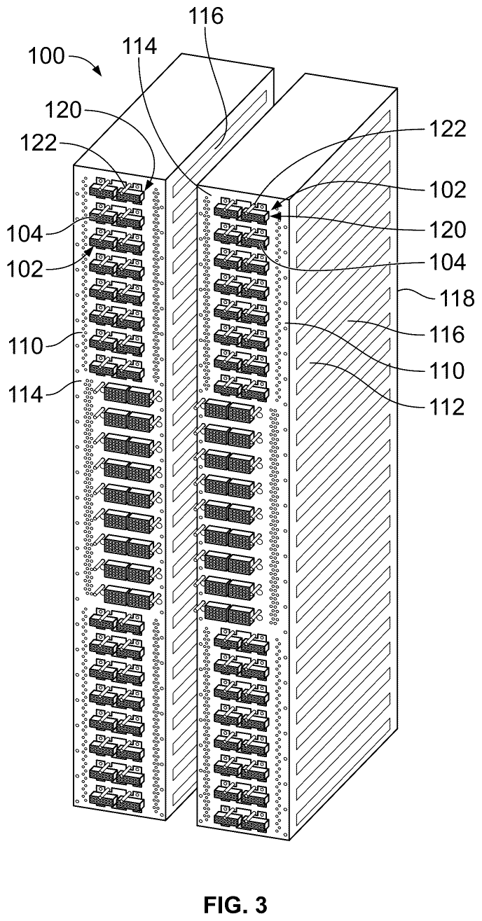

FIG. 3 illustrates a portion of the communication system 100 showing two of the cartridges 110 in accordance with an exemplary embodiment. Each cartridge 110 holds a plurality of the connector assemblies 102, such as in one or more rows and one or more columns. The connector assemblies 102 are provided at the front of the cartridge 110 for interfacing with the mating connector assemblies 104 (shown in FIG. 4).

In an exemplary embodiment, the cartridge 110 is formed from a plurality of panels 112, such as sheet metal panels. The cartridge 110 includes a front panel 114, side panels 116, and a rear panel 118. The panels 112 may additionally include an upper panel and/or a lower panel. The connector assemblies 102 are provided at the front panel 114 for mating with the mating connector assemblies 104. In an exemplary embodiment, the connector assemblies 102 are arranged in a column along the front panel 114. Optionally, the connector assemblies 102 may be provided in multiple columns. The mating ends of the connector assemblies 102 are external to the cartridge 110. For example, the connector assemblies 102 pass through ports or openings 120 in the front panel 114. The connector assemblies 102 are coupled to the front panel 114 adjacent the openings 120. In an exemplary embodiment, the connector assemblies 102 may float or move relative to the front panel 114 to align with and mate to the mating connector assemblies 104. In an exemplary embodiment, the connector assemblies 102 include mating guides, such as guide posts 122, to guide mating of the mating electrical connectors 106 with the connector assemblies 102. The guide posts 122 extend forward of the front panel 114.

FIG. 4 is a perspective view of a portion of the communication system 100 showing one of the mating connector assemblies 104 poised for coupling to the corresponding connector assembly 102. The connector assembly 102 is coupled to the cartridge 110, such as to the front panel 114. In the illustrated embodiment, the mating connector assembly 104 is a network component. For example, the mating connector assembly 104 may be a compute node, a memory module, a network switch, a storage device, a network accelerator, or another type of communication component. The mating connector assembly 104 may be a backplane component or a daughtercard component.

In an exemplary embodiment, the mating connector assembly 104 includes a mating electrical connector 106 mounted to a circuit board 108. The mating connector assembly 104 may be mounted to a front edge of the circuit board 108. The mating electrical connector 106 includes a connector housing 109 holding signal contacts (not shown). The signal contacts are terminated to the circuit board 108. The signal contacts may be socket contacts. The mating electrical connector 106 may includes shields providing shielding for the signal contacts.

The connector assembly 102 is received in the cartridge 110. The connector assembly 102 is provided at the front panel 114 for mating with the mating connector assembly 104 along a mating axis 126. The mating end of the cable connector 130 is configured to pass through an opening in the front panel 114 for mating with the mating electrical connector 106. The connector assemblies 102, 104 are configured to transmit and/or receive data through an interface. In an exemplary embodiment, the identification devices of the connector identification system 200 are contained within the connector assemblies 102 to mate with the mating connector assemblies 104. The connector assemblies 102 may include receptacle connectors and the mating connector assemblies 104 may include plug connectors. In an exemplary embodiment, the guide post 122 is configured to be mated with a guide module 124 of the mating connector assembly 104 to guide mating of the mating connector assembly 104 with the connector assembly 102. In the illustrated embodiment, the guide module 124 includes an opening that receives the guide post 122. The mating guides may be used to align the connectors in one or more lateral directions.

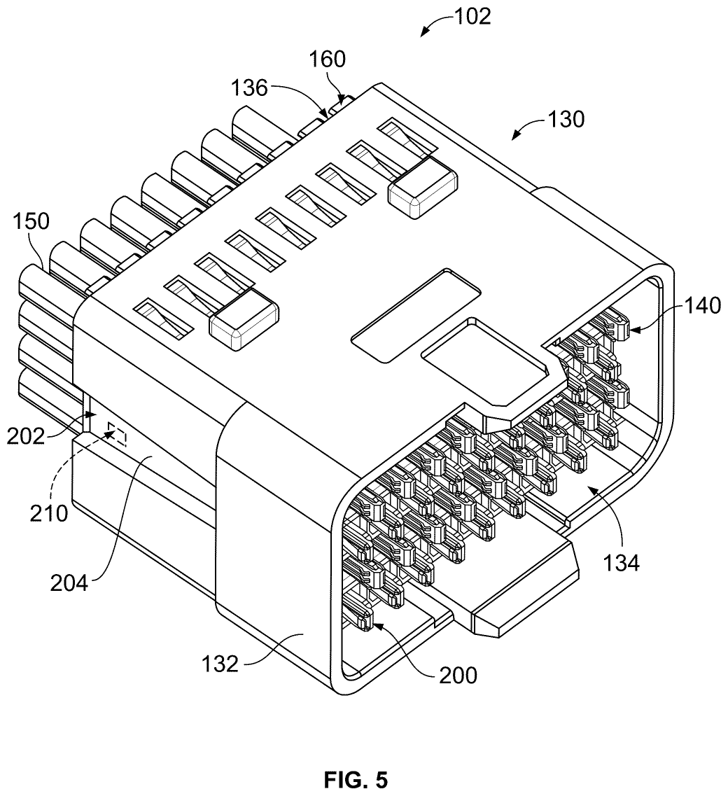

FIG. 5 is a front perspective view of one of the connector assemblies 102 in accordance with an exemplary embodiment. In an exemplary embodiment, the connector assembly 102 includes a cable connector 130 having a connector identification module 202. The connector identification module 202 is part of the connector identification system 200 used to identify the connector assembly 102 within the system. The connector identification module 202 is integrated into the cable connector 130. The connector identification module 202 is configured to be mated to the mating connector assembly 104 with the cable connector 130.

In an exemplary embodiment, the connector identification module 202 includes an identification contact module 204 configured to be plugged into the cable connector 130. The identification contact module 204 includes an identification device 210 holding unique identification data. The identification device 210 is able to uniquely identify the cable connector 130. For example, the identification device 210 is able to identify the cable connector 130 from a plurality of cable connectors, such as within the cartridge 110. The identification device 210 may identify the location of the cable connector 130 or other identifying information about the cable connector 130. In an exemplary embodiment, the identification device 210 is an EEPROM device that is programmable and configured to store unique identification data.

The cable connector 130 includes a connector housing 132 holding the identification contact module 204 and a plurality of communication contact modules 160 configured to transmit data, such as high-speed data signals. The contact modules 160 include contact assemblies 140 configured to be mated with the mating connector assembly 104. The contact assemblies 140 are terminated to ends of cables 150 extending from the cable connector 130. For example, the cables 150 may extend from the rear ends of the contact modules 160. The contact assemblies 140 are arranged together within the contact modules 160. For example, the contact modules 160 hold the contact assemblies 140 in columns. A plurality of the contact modules 160 are received in the connector housing 132, such as being arranged in a contact module stack. The identification contact module 204 may be arranged with the contact modules 160 in the stack. For example, the identification contact module 204 and the contact modules 160 may be arranged side-by-side. In an exemplary embodiment, the identification contact module 204 is arranged in the contact module stack at one of the ends of the contact module stack.

The connector housing 132 includes a cavity 134 that receives the contact modules 160 and the identification contact module 204. The contact assemblies 140 are arranged in the cavity 134 at a mating end for mating with the mating electrical connector 106. For example, the contact assemblies 140 are arranged in the cavity 134 in rows and columns. The identification contact module 204 may include contact assemblies similar to the contact assemblies 140 to similarly mate with the mating electrical connector 106. The cavity 134 may form a receptacle that receives the mating end of the mating electrical connector 106. The walls of the connector housing 132 may be chamfered and have a lead-in surface to guide mating of the mating electrical connector 106 in the cavity 134. The connector housing 132 may have guide features to properly position the mating electrical connector 106 within the cavity 134. In an exemplary embodiment, the connector housing 132 includes a plurality of module slots 136 in the cavity 134. Each module slot 136 receives one of the contact modules 160 or the identification contact module 204. The contact modules 160 and the identification contact module 204 may be latchably coupled to the connector housing 132 in the corresponding module slots 136. In an exemplary embodiment, the contact modules 160 and the identification contact module 204 have similar dimensions and features to be interchangeably received in the module slots 136. For example, the identification contact module 204 may have the same exterior dimensions as the contact modules 160 such that the identification contact module 204 may be plugged into any of the module slots 136 without need to redesign the connector housing 132 to accommodate the identification contact module 204.

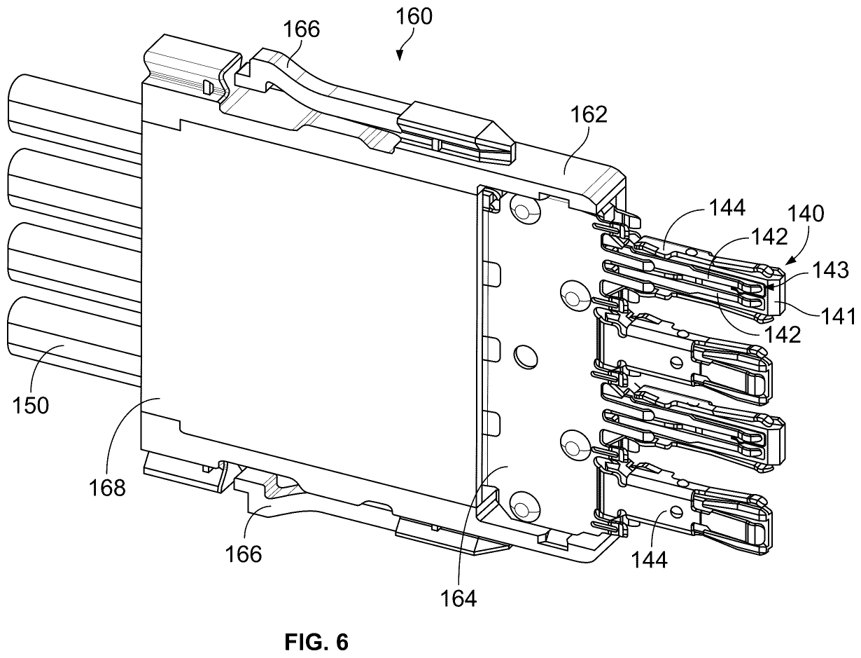

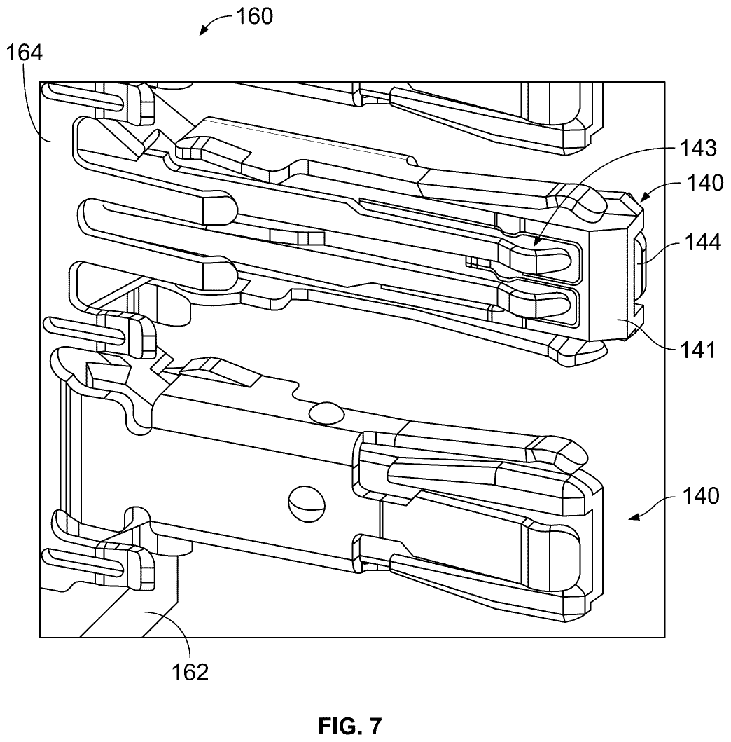

With additional reference to FIG. 6, which is a front perspective view of one of the contact modules 160 in accordance with an exemplary embodiment, and FIG. 7, which is an enlarged view of the mating end of the contact module 160, the contact module 160 includes a structure holding the contact assemblies 140 and the cables 150. For example, the contact module 160 includes a body 162 holding the contact assemblies 140 and the cables 150. The cables 150 extend from a cable end of the contact module 160. The contact assemblies 140 extend from a mating end of the contact module 160.

The body 162 may be generally rectangular having a top, a bottom, a front, a rear, a first side and a second side. The sides may be generally planar and parallel to each other configured to be stacked in the module stack side-by-side with the other contact modules 160. In an exemplary embodiment, the body 162 holds a ground shield 164. The body 162 includes latches 166, such as at the top and the bottom of the body 162, used to secure the contact module 160 in the connector housing 132 (FIG. 5). The contact module 160 may include a strain relief 168, such as at the cable end, configured to hold the ends of the cables 150 and provide strain relief for the cables 150. The strain relief 168 may be an overmold body that is overmolded over the ends of the cables 150.

Each contact assembly 140 includes at least one signal contact 142, a contact holder 141 holding the at least one signal contact 142, and a shield 144 coupled to the contact holder 141 and providing electrical shielding for the at least one signal contact 142. Optionally, multiple contact assemblies 140 may be integrated into a common structure. For example, the contact holders 141 of each of the contact assemblies 140 may be a unitary structure, such as being a single molded piece holding all of the signal contacts 142 and the shields 144.

In the illustrated embodiment, each contact assembly 140 includes a pair of the signal contacts 142, which define a differential pair. In various embodiments, the signal contacts 142 may be deflectable spring beams. However, in alternative embodiments, the signal contacts 142 may be pin contacts, socket contacts, or other types of contacts. The signal contacts 142 may be stamped and formed contacts. Each signal contact 142 is configured to be electrically connected to a corresponding wire or conductor of the cable 150. In an exemplary embodiment, the cable 150 is a twin-axial cable having a first conductor and a second conductor terminated to corresponding signal contacts 142.

The contact holder 141 is manufactured from a dielectric material, such as a plastic material. The contact holder 141 may be a molded part. The contact holder 141 includes a contact channel 143 for each signal contact 142. In the illustrated embodiment, the contact holder 141 has two contact channels 143 for the pair of signal contacts 142. In various embodiments, the contact holder 141 is preformed and the signal contacts 142 are loaded into the contact holder 141. In other various embodiments, the contact holder 141 is formed in situ around the signal contacts 142, such as being overmolded over the signal contacts 142. The cable 150 may extend into an end of the contact holder 141 to terminate to the signal contacts 142. The contact holder 141 may provide strain relief for the end of the cable 150. In other embodiments, a single contact holder may be provided for the contact module 160 configured to hold each of the pairs of the signal contacts 142, such as four pairs of the signal contacts 142 in a single molded part.

The shield 144 may be a stamped and formed shield. The shield 144 is configured to be coupled to the contact holder 141. Optionally, shields may be provided at both sides of the contact module 160. The shield 144 may provide shielding on multiple sides of the signal contacts 142. In an exemplary embodiment, the front end of the shield 144 is C-shaped providing electrical shielding on three sides of the pair of signal contacts 142. The shield 144 may have other shapes in alternative embodiments. The shield 144 may have deflectable spring beams configured to be mated to a shield structure of the mating connector assembly 104. The shield 144 may be configured to be electrically connected to the cable shield of the cable.

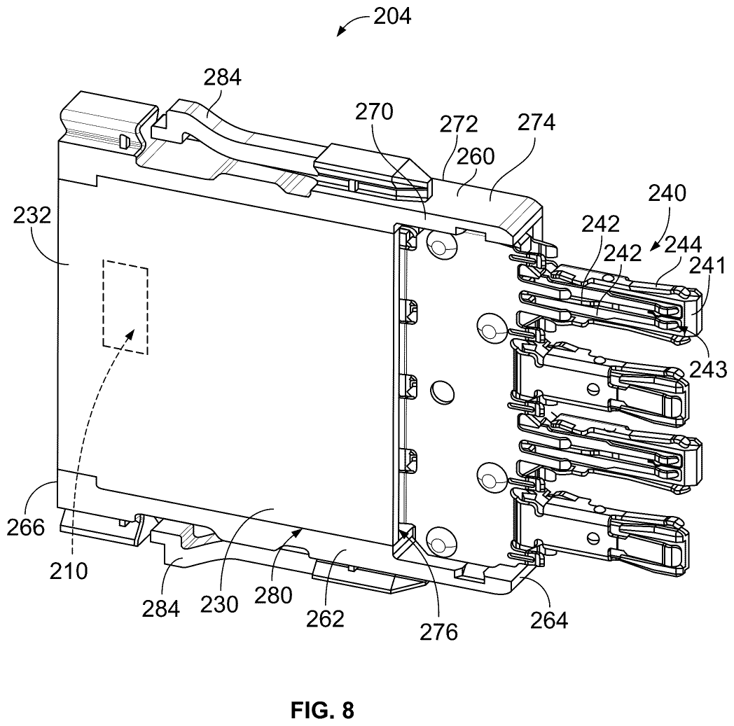

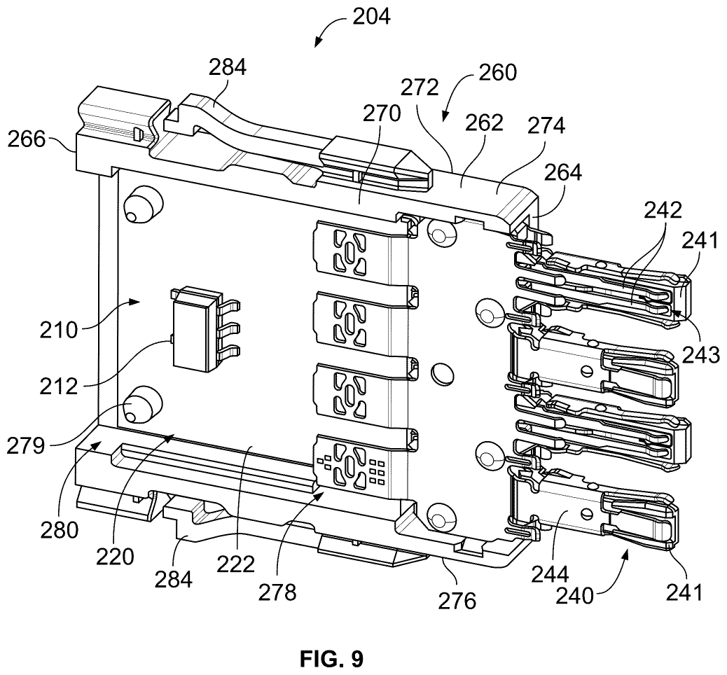

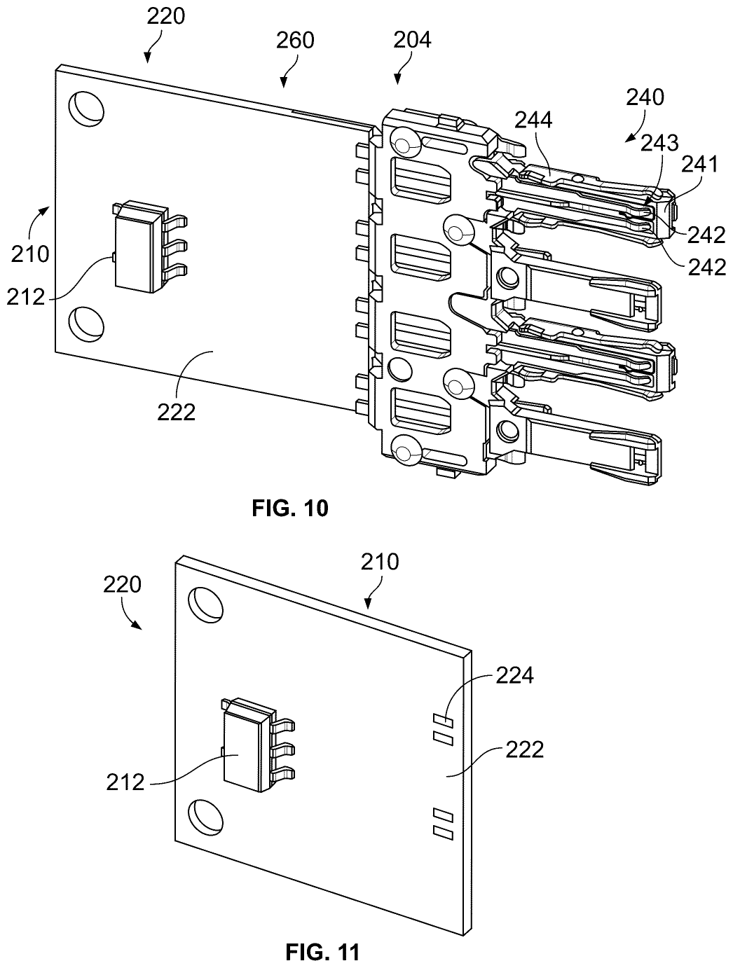

FIG. 8 is a perspective view of the identification contact module 204 in accordance with an exemplary embodiment. FIG. 9 is a perspective view of a portion of the identification contact module 204 in accordance with an exemplary embodiment with a device shell of the identification contact module 204 removed to illustrate internal components of the identification contact module 204. FIG. 10 is a perspective view of a portion of the identification contact module 204 in accordance with an exemplary embodiment with a housing of the identification contact module 204 removed to illustrate internal components of the identification contact module 204. FIG. 11 is a perspective view of a portion of the identification contact module 204 in accordance with an exemplary embodiment showing the identification device 210. The identification contact module 204 may be similar to the signal contact module 160 (shown in FIG. 7). For example, the identification contact module 204 and the contact module 160 may have similar dimensions and components. The identification contact module 204 and the contact module 160 may be interchangeable within the contact module stack and arranged in the connector housing 132 for mating with the mating connector assembly 104.

In an exemplary embodiment, the identification contact module 204 includes a plurality of the contact assemblies 240 configured to be mated with the mating connector assembly 104 and the identification device 210 operably coupled to the contact assemblies 240.

In an exemplary embodiment, the identification device 210 includes an electronic device 212 that stores unique identification data. The electronic device 212 may be an integrated circuit, such as a chip. In an exemplary embodiment, the electronic device 212 is an EEPROM device, such as an EEPROM chip or component. The electronic device 212 is programmable to store the identification data, such as a part number, a program name, a slot ID number, and the like. The electronic device 212 may be a surface mount component, such as having solder tails, solder pads, solder balls, or other conductors or leads for connection to another component, such as a circuit board or directly to the contacts of the contact assemblies 240.

In an exemplary embodiment, the identification device 210 includes a printed circuit board assembly 220 including a printed circuit board 222, the electronic device 212 mounted to the printed circuit board 222, and may include other components mounted to the printed circuit board 222, such as capacitors, resistors, a processor, a memory module, or another component. The printed circuit board 222 includes pads 224 on one or more surfaces of the printed circuit board 222. The pads 224 may be provided proximate to the edge, such as for connection to the contact assemblies 240.

In an exemplary embodiment, the identification device 210 includes a device shell 230 (FIG. 8) holding the printed circuit board assembly 220. The device shell 230 surrounds the printed circuit board 222 and the electronic device 212. In an exemplary embodiment, the device shell 230 includes an overmold body 232 overmolded over the printed circuit board assembly 220. In alternative embodiments, the device shell 230 may include multiple shells coupled together to hold the printed circuit board assembly 220 therebetween. The device shell 230 surrounds the printed circuit board assembly 220 to protect the components, such as the electronic device 212.

The identification contact module 204 includes a plurality of the identification contact assemblies 240. The identification contact assemblies 240 may be similar to the contact assemblies 140 (shown in FIG. 7). Each contact assembly 240 includes at least one identification contact 242, a contact holder 241 holding the at least one identification contact 242, and a shield 244 coupled to the contact holder 241 and providing electrical shielding for the at least one identification contact 242. Optionally, multiple contact assemblies 240 may be integrated into a common structure. For example, the contact holders 241 of each of the contact assemblies 240 may be a unitary structure, such as being a single molded piece holding all of the identification contacts 242 and the shields 244.

In various embodiments, the contact assembly 240 may include multiple identification contacts 242. The identification contacts 242 may transmit power to the identification device 210. The identification contacts 242 may be signal contacts, power contacts, ground contacts, or other types of contacts. In various embodiments, the identification contacts 242 may be deflectable spring beams. However, in alternative embodiments, the identification contacts 242 may be pin contacts, socket contacts, or other types of contacts. The identification contacts 242 may be stamped and formed contacts. Each identification contact 242 is configured to be electrically connected to the identification device 210, such as being terminated to the printed circuit board 222.

The contact holder 241 is manufactured from a dielectric material, such as a plastic material. The contact holder 241 may be a molded part. The contact holder 241 includes a contact channel 243 for each identification contact 242. In the illustrated embodiment, the contact holder 241 has two contact channels 243 for the pair of identification contacts 242. In various embodiments, the contact holder 241 is preformed and the identification contacts 242 are loaded into the contact holder 241. In other various embodiments, the contact holder 241 is formed in situ around the identification contacts 242, such as being overmolded over the identification contacts 242. In other embodiments, a single contact holder may be provided for the contact module 204 configured to hold each of the pairs of the identification contacts 242, such as three pairs of the identification contacts 242 in a single molded part.

The shield 244 may be a stamped and formed shield. The shield 244 is configured to be coupled to the contact holder 241. Optionally, shields may be provided at both sides of the contact module 204. The shield 244 may provide shielding on multiple sides of the identification contacts 242. In an exemplary embodiment, the front end of the shield 244 is C-shaped providing electrical shielding on three sides of the pair of identification contacts 242. The shield 244 may have other shapes in alternative embodiments. The shield 244 may have deflectable spring beams configured to be mated to a shield structure of the mating connector assembly 104.

In an exemplary embodiment, the identification contact module 204 includes an identification module housing 260 configured to hold the identification contact assemblies 240 and the identification device 210 and configured to be coupled to the connector housing 132 of the cable connector 130. The identification module housing 260 includes a housing body 262 extending between a front 264 and a rear 266. The housing body 262 includes a first side 270 and a second side 272. The housing body 262 includes a top 274 and a bottom 276. The identification module housing 260 includes an inner cavity 278 at least partially surrounded by the housing body 262.

The identification contact assemblies 240 are received in the inner cavity 278 and held by the housing body 262. For example, the contact holder(s) 241 may be coupled to the housing body 262. In an exemplary embodiment, the contact assemblies 240 are provided at the front 264. The contact holders 241 and the mating ends of the identification contacts 242 may extend forward of the front 264, such as for mating with the mating connector assembly 104.

The identification device 210 is received in the inner cavity 278 and held by the housing body 262. For example, the housing body 262 may include posts 279 configured to hold the printed circuit board 222. The posts 279 may be heat staked to secure the printed circuit board 222 in the inner cavity 278. Other securing features may be used in alternative embodiments, such as latches, clips, fasteners, and the like.

In an exemplary embodiment, the housing body 262 includes an opening 280 at the first side 270 open to the inner cavity 278. The contact assemblies 240 and the identification device 210 may be received in the inner cavity 278 through the opening 280. In an exemplary embodiment, at least a portion of the opening 280 may be closed by the device shell 230 (FIG. 8). For example, the device shell 230 may be attached to the identification device 210, such as to the printed circuit board 222. The device shell 230 may be formed in place in the inner cavity 278. For example, the device shell 230 may be an overmold or hot melt at least partially filling the inner cavity 278. In various embodiments, the device shell 230 may be flush with the first side 270.

In an exemplary embodiment, the housing body 262 may be generally rectangular. The first and second sides 270, 272 may be generally planar and parallel to each other configured to be stacked in the module stack side-by-side with the other contact modules 160. In an exemplary embodiment, the identification device 210 is contained within the inner cavity 278 of the housing body 262. The identification device 210 is contained between the front 264 and the rear 266, between the top 274 and the bottom 276, and between the first side 270 and the second side 272. For example, the identification device 210 does not protrude from the sides allowing the identification contact module 204 to be stacked with the contact modules 160 in the cable connector 130.

In an exemplary embodiment, the identification module housing 260 includes latches 284, such as at the top 274 and the bottom 276 of the housing body 262. The latches 284 are used to secure the identification contact module 204 in the connector housing 132 of the cable connector 130.

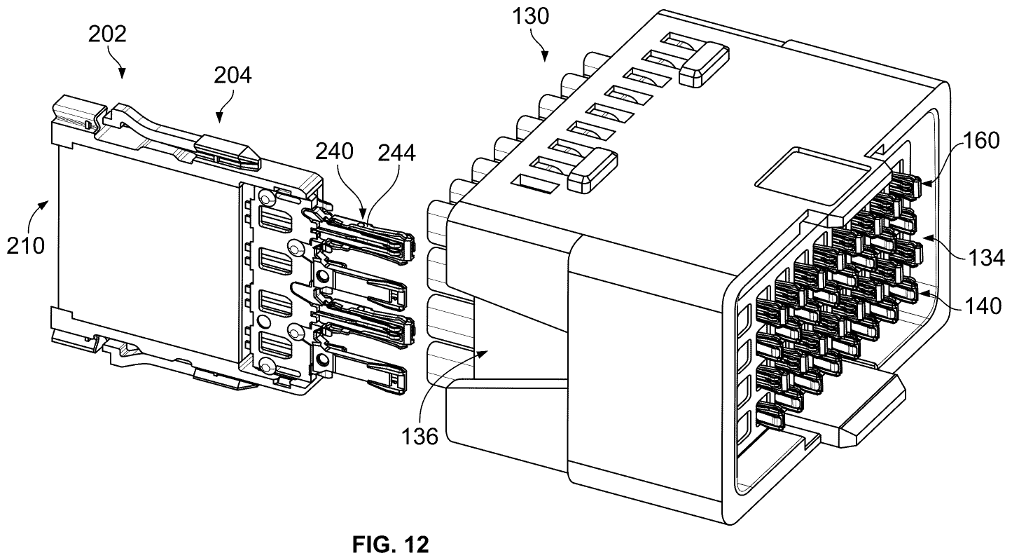

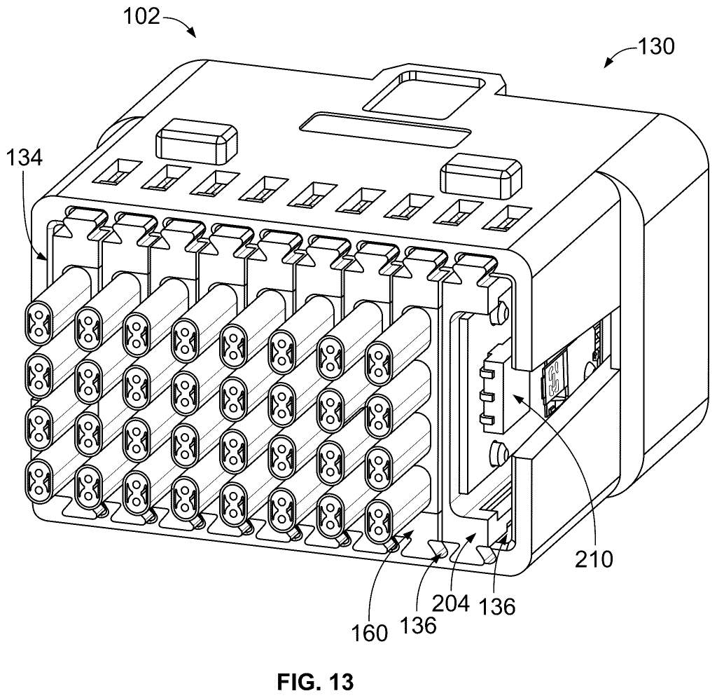

FIG. 12 is a front perspective view of the cable connector 130 showing the identification contact module 204 poised for loading into the cable connector 130. FIG. 13 is a rear perspective view of the cable connector 130 showing the identification contact module 204 loaded into the cable connector 130. In an exemplary embodiment, the identification contact module 204 is rear loaded into the cavity 134, such as into the corresponding module slot 136. The identification contact module 204 is configured to be arranged in the module stack with the other contact modules 160. The connector identification module 202 and the contact modules 160 may be interchangeably receivable in the contact assembly slots 136. For example, because the connector identification module 202 and the contact modules 160 have the same dimensions and mating features, the connector identification module 202 may be arranged in any of the slots. When assembled, the contact assemblies 140 and the identification contact assemblies 240 are arranged at the mating end of the cable connector 130, such as at the front of the cable connector 130. The contact assemblies 140 and the identification contact assemblies 240 may be arranged in the receptacle for mating with the mating electrical connector 106.

The identification device 210 of the identification contact module 204 is operably coupled to the identification contact assemblies 240. The identification device 210 is configured to be electrically coupled to the mating electrical connector 106 by the identification contact assemblies 240. The identification device 210 is used to identify the connector assembly 102 associated with the connector identification module 202. The identification device 210 may be used to identify physical locations of the connector assembly 102 within the communication system 100. In an exemplary embodiment, the identification device 210 may be an EEPROM. The identification device 210 holds information that allows identification of the connector assembly 102. The identification device 210 may have unique identification information programmed into the identification device 210, such as a part number, a program name, a slot ID number, and the like. The identification device 210 is operably coupled to the identification contacts 242 to transmit the unique identification data to the mating connector assembly 104.

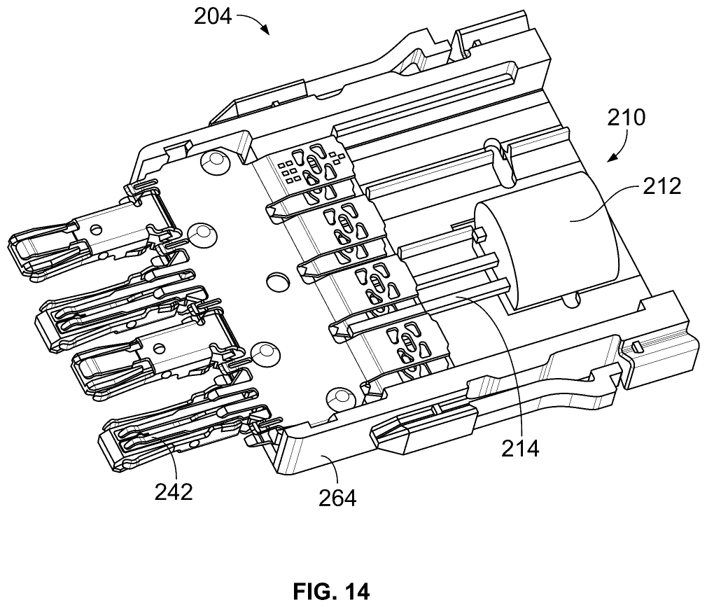

FIG. 14 is a perspective view of the identification contact module 204 showing an electronic device 212 of the identification device 210 in accordance with an exemplary embodiment. The electronic device 212 is an EEPROM device. The electronic device 212 includes leads 214 extending from the body of the electronic device 212. The leads 214 are configured to be terminated directly to the corresponding identification contacts 242. The identification device 210 is provided without a printed circuit board. The electronic device 212 may be coupled to the housing body 262 of the identification module housing 260.

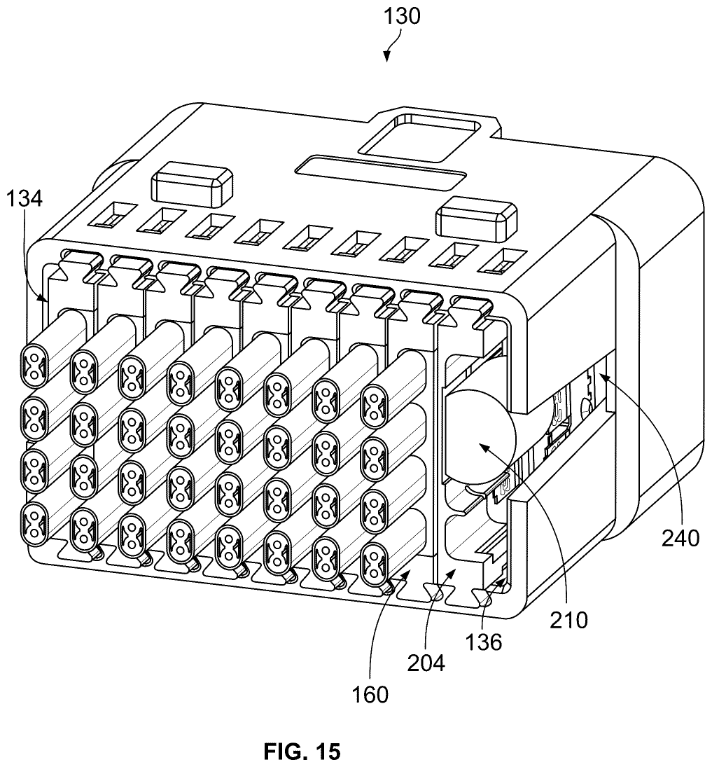

FIG. 15 is a rear perspective view of the cable connector 130 showing the identification contact module 204 shown in FIG. 14 loaded into the cable connector 130. In an exemplary embodiment, the identification contact module 204 is rear loaded into the cavity 134, such as into the corresponding module slot 136. The identification contact module 204 is configured to be arranged in the module stack with the other contact modules 160. The identification device 210 of the identification contact module 204 is operably coupled to the identification contact assemblies 240. The identification device 210 is configured to be electrically coupled to the mating electrical connector 106 by the identification contact assemblies 240. The identification device 210 is used to identify the connector assembly 102 associated with the connector identification module 202. The identification device 210 may be used to identify physical locations of the connector assembly 102 within the communication system 100. In an exemplary embodiment, the identification device 210 may be an EEPROM. The identification device 210 holds information that allows identification of the connector assembly 102. The identification device 210 may have unique identification information programmed into the identification device 210, such as a part number, a program name, a slot ID number, and the like. The identification device 210 is operably coupled to the identification contacts 242 to transmit the unique identification data to the mating connector assembly 104.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A cable connector assembly comprising:
a cable connector including a connector housing extending between a mating end and a cable end, the connector housing having walls defining a cavity, the cable connector including cable modules received in the cavity, each cable module including a module housing, signal contacts held by the module housing, and cables held by the module housing, the signal contacts arranged at the mating end and configured to be mated with a mating connector assembly, the cables terminated to the signal contacts and extending from the cable end of the cable connector, the cables defining data channels; and
a connector identification module received in the cavity and configured to be mated with the mating connector assembly, the connector identification module including an identification module housing, identification contacts held by the identification module housing, and an identification device held by the identification module housing, the identification contacts arranged at the mating end and configured to be mated with the mating connector assembly, the identification device having unique identification data stored on the identification device, the identification device being operably coupled to the identification contact to transmit the unique identification data to the mating connector assembly.

2. The cable connector assembly of claim 1, wherein the cable modules and the connector identification module are arranged in a module stack side-by-side in the cavity of the connector housing.

3. The cable connector assembly of claim 1, wherein the connector housing includes housing slots in the cavity, the module housings and the identification module housing have similar dimensions configured to be interchangeably received in the housing slots.

4. The cable connector assembly of claim 1, wherein the identification device includes a printed circuit board assembly including a printed circuit board and an electronic device mounted to the printed circuit board, the unique identification data being stored on the electronic device, the identification contacts being terminated to the printed circuit board.

5. The cable connector assembly of claim 1, wherein the identification device is an EEPROM device.

6. The cable connector assembly of claim 1, wherein the connector identification module includes a device shell surrounding the identification device.

7. The cable connector assembly of claim 1, wherein the connector identification module includes shields providing shielding for the identification contacts.

8. The cable connector assembly of claim 1, wherein each module housing includes latches being latchably coupled to the connector housing to secure the cable module in the cavity, the identification module housing including latches being latchably coupled to the connector housing to secure the connector identification module in the cavity.

9. The cable connector assembly of claim 1, wherein the connector identification module includes contact holders holding the identification contacts in pairs, the connector identification module including shields coupled to the contact holders to provide shielding for the identification contacts, the identification device includes a printed circuit board assembly including a printed circuit board and an electronic device mounted to the printed circuit board, the unique identification data being stored on the electronic device, the contact holders located forward of the printed circuit board, the identification contacts and the shields being terminated to the printed circuit board.

10. A connector identification module comprising:
identification module housing including a housing body extending between a front and a rear, the housing body including a first side and a second side, the housing body including a top and a bottom, the identification module housing including an inner cavity at least partially surrounded by the housing body;
an identification contact assembly received in the inner cavity and held by the housing body, the identification contact assembly including a contact holder holding identification contacts, the identification contacts including mating ends extending forward of the front of the housing body for mating with a mating connector assembly; and
an identification device received in the inner cavity and held by the housing body, the identification device having unique identification data stored on the identification device, the identification device being operably coupled to the identification contacts to transmit the unique identification data to the mating connector assembly.

11. The connector identification module of claim 10, wherein the identification device includes a printed circuit board assembly including a printed circuit board and an electronic device mounted to the printed circuit board, the unique identification data being stored on the electronic device, the identification contacts being terminated to the printed circuit board.

12. The connector identification module of claim 10, wherein the identification device is an EEPROM device.

13. The connector identification module of claim 10, wherein the identification device includes an electronic device storing the unique identification data and a device shell surrounding the electronic device, the device shell at least partially filling the inner cavity.

14. The connector identification module of claim 10, wherein the identification contact assembly includes shields providing shielding for the identification contacts.

15. The connector identification module of claim 10, wherein the identification module housing including latches at the top and the bottom of the housing body configured to be latchably coupled to a connector housing of a connector assembly.

16. The connector identification module of claim 10, wherein the housing body includes an opening at the first side open to the inner cavity, the contact assembly and the identification device being received in the inner cavity through the opening.

17. The connector identification module of claim 10, wherein the identification device is contained within the inner cavity of the housing body between the front and the rear, between the top and the bottom, and between the first and second sides.

18. A communication system comprising:
a cartridge having panels forming a chamber, the cartridge including ports at a front of the cartridge;
cable connector assemblies received in the ports for mating with mating connector assemblies, each cable connector assembly including a cable connector and a connector identification module,
the cable connector including a connector housing extending between a mating end and a cable end, the connector housing having walls defining a cavity, the cable connector including cable modules received in the cavity, each cable module including a module housing, signal contacts held by the module housing, and cables held by the module housing, the signal contacts arranged at the mating end and configured to be mated with the corresponding mating connector assembly, the cables electrically connected to the signal contacts and extending from the cable end of the cable connector, the cables defining data channels; and
the connector identification module received in the cavity and configured to be mated with the mating connector assembly, the connector identification module including an identification module housing, identification contacts held by the identification module housing, and an identification device held by the identification module housing, the identification contacts arranged at the mating end and configured to be mated with the mating connector assembly, the identification device having unique identification data stored on the identification device, the identification device being operably coupled to the identification contact to transmit the unique identification data to the mating connector assembly.

19. The communication system of claim 18, wherein the connector identification modules uniquely identify the positions of the corresponding cable connector assemblies within the communication system based on the unique identification data.

20. The communication system of claim 18, wherein the identification device is an EEPROM device.
